(19) United States
(12) Patent Application Publication
(10) Pub. No.: US 2010/0307286 A1
(43) Pub. Date: Dec. 9, 2010

(54) DUAL CONIC-SHAPED FLYING WHEEL

(76) Inventor: TENG-HUI HUANG, Feng Yuan City (TW)

Correspondence Address: LEONG C. LEI, PMB # 1008, 1839 YGNACIO VALLEY ROAD, WALNUT CREEK, CA, 94598, US

(21) Appl. No.: 12/477,919

(22) Filed: Jun. 4, 2009

(51) Int. Cl. F16F 15/315

(52) U.S. Cl. 74/572.21

(57) ABSTRACT

A dual conic-shaped flying wheel is disclosed. The first and the second conic housings are combined together and the interior of the two housings are filled with a filler such as cement mixture or lead.

### TECHNICAL FIELD OF THE INVENTION

The present invention relates to flying wheel, and in particular to a flying wheel with low resistance and high rotating performance.

### DESCRIPTION OF THE PRIOR ART

Conventional flying wheel are made from metal formed as a unit. These flying wheels have a big volume and thickness and heavy in weight and therefore they cannot be easily machining but can only machining using laser technology.

Another drawback is that these flying wheel can be formed from raw iron by mean of casting. These method of machining as fabrication and expensive and not convenient. The big volume and the heavy weight are not convenient in shipping and therefore, further or secondary fabrication is not easy. In view of these drawbacks, the quality of the flying wheel cannot be improved. Further, due to the increase in cost of metal, the cost of manufacturing metal flying wheel is increased.

Accordingly, it is an object of the present invention to provide a dual conic-shaped flying wheel which mitigates the above mentioned-drawbacks.

### SUMMARY OF THE INVENTION

It is an object of the present invention to provide a dual conic-shaped flying wheel comprising a first conic housing and a second conic housing, characterized in that the first conic housing is a semi cone with one open circular end having a circular edge being provided with a plurality of through holes, the center of the housing is an axle collar with aperture and is having a plurality of holes along the edge thereof, the inner side of the axle collar is extended to form axle protection tube, and the top section of the axle collar protection tube is a connection circular disc having through holes, the connection circular disc is provided with through holes and between every each through hole of the axle collar and every each through hole of the connection circular disc is hollow tube, and at the external of the protection tube, and at the internal surface of the first conic housing is provided with equal spaced apart reinforcing ribs, a filler fills the internal of the first conic housing and the filler, the flat circular edge and the connection circular disc are at the same plane; the second conic housing is a semi cone with one open circular end having a circular edge being provided with a plurality of through holes, the center of the housing is an axle collar with aperture and is having a plurality of holes along the edge thereof, the inner side of the axle collar is extended to form axle protection tube, and the top section of the axle collar protection tube is a connection circular disc having through holes, the connection circular disc is provided with through holes and between every each through hole of the axle collar and every each through hole of the connection circular disc is hollow tube, and at the external of the protection tube, and at the internal surface of the first conic housing is provided with equal spaced apart reinforcing ribs, a filler fills the internal of the first conic housing and the filler, the flat circular edge and the connection circular disc are at the same plane; the first conic-shaped housing and the second conic-shaped housing are combined together with the base thereof, and a long screw bolt passes through each of the through holes of the axle collar, the long screw bolt in term passes through the hollow tube, the through holes of the connection circular disc, the through holes of the first conic-shaped housing, and the through holes of the connection circular disc of the second conic-shaped housing, the long screw nut is then fastened with a screw nut, and the through holes of the first conic-shaped housing and that of the second conic-shaped housing are mounted and fastened with a plurality of screws and nuts.

Yet still another object of the present invention to provide a dual conic-shaped flying wheel, wherein the filler is cement mixture or lead.

Other objects, and advantages will become more apparent in view of the following detailed description in conjunction with the accompanying drawings.

### BRIEF DESCRIPTION OF THE DRAWINGS

FIG. 1 is an exploded perspective view of a dual conic-shaped flying wheel in accordance with the present invention, wherein the first and second conic housings are shown.

FIG. 2 is a perspective view of the dual conic-shaped flying wheel, wherein the first and second conic housings are combined with each other using a long screw bolt.

FIG. 3 is a sectional view of the dual conic-shaped flying wheel of the present invention.

FIG. 4 is a perspective view of the dual conic-shaped flying wheel of the present invention.

### DETAILED DESCRIPTION OF THE PREFERRED EMBODIMENTS

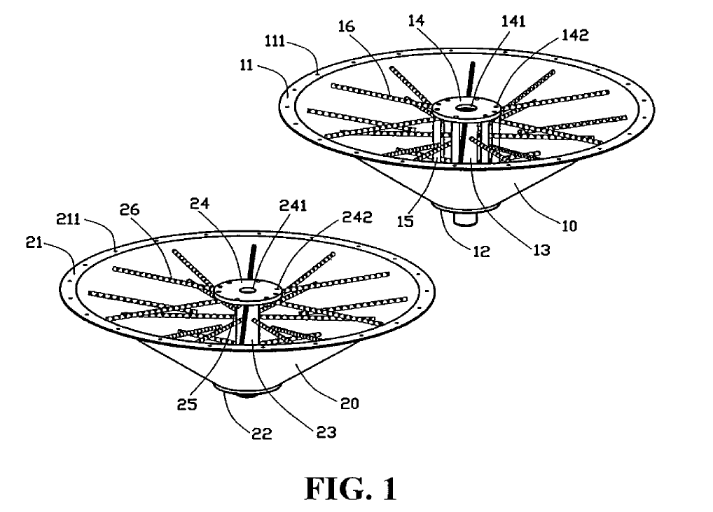

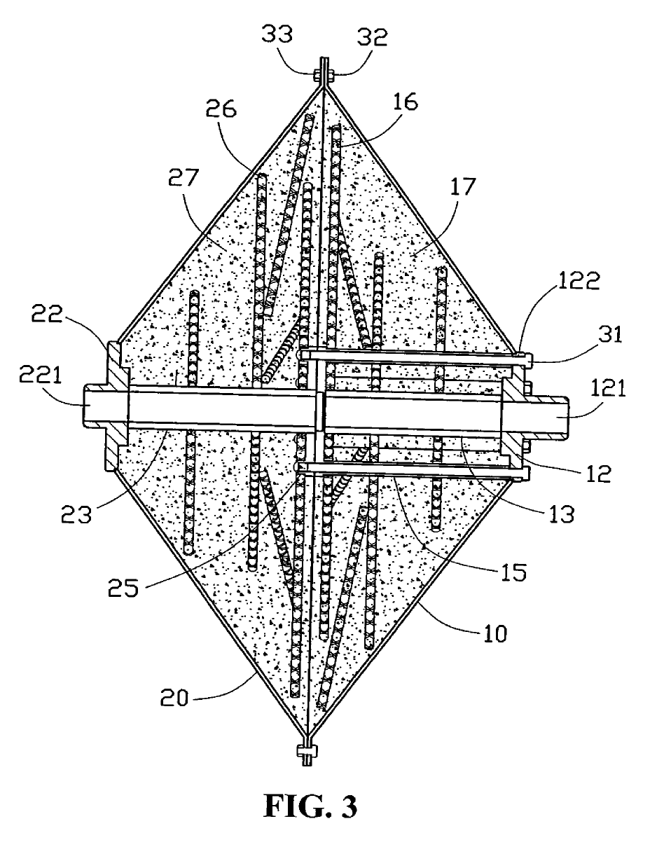

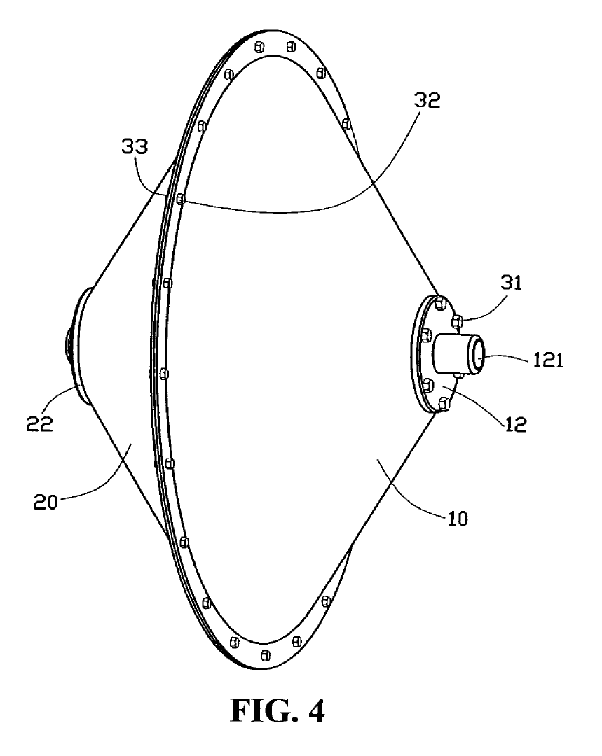

Referring to FIGS. 1 to 4, there is shown the structure of a dual conic-shaped flying wheel in accordance with the present invention. The flying wheel comprises a first conic housing 10 and a second conic housing 20 combined together.

The first conic housing 10 is a semi cone structure with one open circular end extended to form into a flat circular edge 11 having a plurality of through holes 111. The center of the housing 10 is an axle collar 12 with aperture 121 and is having a plurality of through holes 122 along the edge thereof. The inner side of the axle collar 12 is extended to form an axle collar protection tube 13. The top section of the axle collar protection tube 13 is a connection circular disc 14 having a plurality of through holes 142. The connection circular disc 14 is provided with a plurality of through holes 142 and between every each through holes 122 of the axle collar 12 and every each through holes 142 of the circular disc 14 is hollow tube 15, and at the external of the axle collar protection tube 15, and at the internal surface of the first conic housing 10, equal spaced apart reinforcing ribs 16 are provided. The interior of the first conic housing 10 is filled with a filler 17 and the filler 17 and the flat circular edge 11 and the connection circular disc 14 are on the same plane.

The second conic housing 20 has substantially a similar structure. The second conic-shaped housing 20 is a semi cone structure with an open circular end extended to form into a flat circular edge 21 having a plurality of through holes 211. The center of the second housing 20 is an axle collar 22 with aperture 221, and the inner side of the axle collar 22 is extended to form an axle collar protection tube 23 is a connection circular disc 24 having a plurality of through holes 242. The connection circular disc 24 is provided with a plurality of through holes 242 and between every each through hole 242 of the circular disc 24 there is provided with a screw nut 25. The axle protection tube 23 and the inner face of the second housing 20 are provided with equal space apart reinforcing ribs 26.

After that the interior of the second conic housing 20 is filled with a filler 27. The filler 27 and the flat circular edge 21 and the connection circular disc 24 are on the same plane.

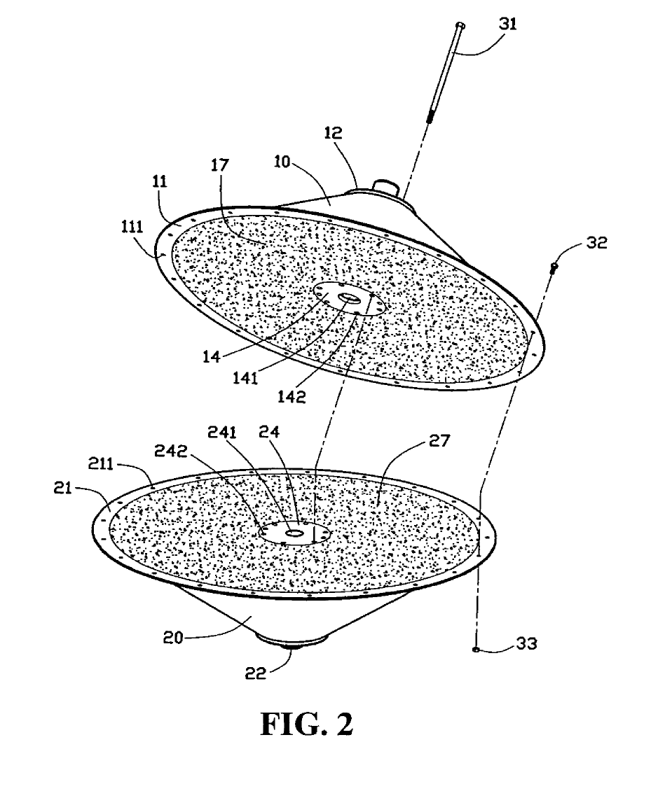

FIGS. 2 to 4 show how the conic-shaped housings 10, 20 are combined to form the flying wheel of the present invention. The through holes 122 of the axle collar 12 of the first conic-shaped housing 10 is inserted with a long screw bolt 31. In sequence, the screw bolt 31 passes through the aperture 15, the through holes 142 of the connection circular disc 14, the through hole 242 of the connection circular disc 24 of the second conic-shaped housing 20 and the screw bolt 31 is fastened with a screw nut 25. The through holes 111, 211 are passed through with screws 32 which are fastened by screw nuts 33. Thus, the first and second conic housings 10, 20 are combined. In accordance with the present invention, a flying wheel with dual conic shape is obtained. The flying wheel has low air resistance and the rotating efficiency is improved.

The interior of the first and second conic housings 10, 20 are filled with a filler 17-27, which could be a cement mixture or lead or other suitable material.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A dual conic-shaped flying wheel comprising a first conic housing and a second conic housing, characterized in that
the first conic housing is a semi cone with one open circular end having a circular edge being provided with a plurality of through holes, the center of the housing is an axle collar with aperture and is having a plurality of holes along the edge thereof, the inner side of the axle collar is extended to form axle protection tube, and the top section of the axle collar protection tube is a connection circular disc having through holes, the connection circular disc is provided with through holes and between every each through hole of the axle collar and every each through hole of the connection circular disc is hollow tube, and at the external of the protection tube, and at the internal surface of the first conic housing is provided with equal spaced apart reinforcing ribs, a filler fills the internal of the first conic housing and the filler, the flat circular edge and the connection circular disc are at the same plane;
the second conic housing is a semi cone with one open circular end having a circular edge being provided with a plurality of through holes, the center of the housing is an axle collar with aperture and is having a plurality of holes along the edge thereof, the inner side of the axle collar is extended to form axle protection tube, and the top section of the axle collar protection tube is a connection circular disc having through holes, the connection circular disc is provided with through holes and between every each through hole of the axle collar and every each through hole of the connection circular disc is hollow tube, and at the external of the protection tube, and at the internal surface of the first conic housing is provided with equal spaced apart reinforcing ribs, a filler fills the internal of the first conic housing and the filler, the flat circular edge and the connection circular disc are at the same plane;
the first conic-shaped housing and the second conic-shaped housing are combined together with the base thereof, and a long screw bolt passes through each of the through holes of the axle collar, the long screw bolt in term passes through the hollow tube, the through holes of the connection circular disc, the through holes of the first conic-shaped housing, and the through holes of the connection circular disc of the second conic-shaped housing, the long screw nut is then fastened with a screw nut, and the through holes of the first conic-shaped housing and that of the second conic-shaped housing are mounted and fastened with a plurality of screws and nuts.

2. The flying wheel of claim 1, wherein the filler is cement mixture or lead.
